(19) United States
(12) Patent Application Publication
(10) Pub. No.: US 2008/0304029 A1
(43) Pub. Date: Dec. 11, 2008

(54) Method and System for Adjusting an Optical Model

(75) Inventors: Rainer Pforr, Dresden, Weixdorf (DE); Thorsten Winkler, Unterhaching (DE); Ralf Ziebold, Radebeul (DE); Wolfram Kostler, Langbrueck (DE); Jens Reichelt, Dresden (DE); Stefan Blawid, Dresden (DE); Sebastian Champigny, Munchen (DE); Manuel Vorwerk, Dresden (DE)

Correspondence Address: EDELL, SHAPIRO & FINNAN, LLC, 1901 RESEARCH BLVD., SUITE 400, ROCKVILLE, MD, 20850, US

(73) Assignee: QIMONDA AG, Munich (DE)

(21) Appl. No.: 11/760,295

(22) Filed: Jun. 8, 2007

(51) Int. Cl. G03B 27/14

(52) U.S. Cl. 355/44

(57) ABSTRACT

In a method of adjusting an optical parameter of an exposure apparatus, a photolithographic projection is performed using an exposure apparatus and using a layout pattern so as to provide measured layout data with different focus settings of the exposure apparatus. An optical model is provided including at least one optical parameter and a simulated image is created by using the optical model and the layout pattern. The optical model is optimized by modifying the optical parameter.

### BACKGROUND

The process of lithographic projection of light patterns onto photo resist layers is commonly used to form structures and features in integrated circuits. Implementation of such processes typically involves computer simulation of expected patterns formed by lithographic projection using certain optical parameters. It is desirable to improve the dimensional accuracy of such simulations of lithographic projection processes.

### SUMMARY

In a method of adjusting an optical parameter of an exposure apparatus, a photolithographic projection is performed using an exposure apparatus and using a layout pattern so as to provide measured layout data with different focus settings of the exposure apparatus. An optical model is provided including at least one optical parameter and a simulated image is created by using the optical model and the layout pattern. The optical model is optimized by modifying the optical parameter.

### BRIEF DESCRIPTION OF THE DRAWINGS

In the accompanying drawings:

FIG. 1 illustrates an optical projection system;

FIG. 2 illustrates a layout pattern in a top view;

FIG. 3 illustrates a characterization of CD-values for different orientations;

FIG. 4A illustrates a characterization of structural feature sizes of a pattern according to an embodiment;

FIG. 4B illustrates a characterization of structural feature sizes of a pattern according to a further embodiment;

FIG. 5A illustrates a characterization of fit accuracy for different focus settings according to a further embodiment;

FIG. 5B illustrates a characterization of fit accuracy for different focus settings according to a further embodiment;

FIG. 6 illustrates a flow chart of method steps for performing an optical simulation;

FIGS. 7A and 7B each illustrate a simulated resist pattern in a top view with respect to a first aberration parameter;

FIGS. 8A and 8B each illustrate a simulated resist pattern in a top view with respect to a second aberration parameter;

FIGS. 9A and 9B each illustrate a measured resist pattern;

FIG. 10 illustrates a flow chart of method steps for performing an optical simulation for optical proximity correction;

FIG. 11 illustrates a flow chart of method steps for performing an optical simulation for circuit optimization; and

FIG. 12 illustrates a system for adjusting an optical parameter.

### DETAILED DESCRIPTION

Embodiments of methods and systems for adjusting an optical parameter are discussed in detail below. It is appreciated, however, that the present invention provides many applicable inventive concepts that can be embodied in a wide variety of specific contexts. The specific embodiments discussed are merely illustrative of specific ways and do not limit the scope of the invention.

In the following, embodiments of the method and the system are described with respect to improving dimensional accuracy during simulation of lithographic projection of a layer of an integrated circuit. The embodiments, however, might also be useful in other respects, e.g., pattern fidelity of two-dimensional structures, improvements in process window calculations, improvements in identifying critical parts of a layout of a pattern, yield enhancement techniques or layout simulation capabilities.

Furthermore, it should be noted that the embodiments are described with respect to line-space patterns but might also be useful in other respects including but not limited to dense patterns, semi-dense patterns or patterns with isolated lines and combinations between all them. Lithographic projection can also be applied during manufacturing of different products, e.g., semiconductor circuits, thin film elements. Other products, e.g., liquid crystal panels or the like might be produced as well.

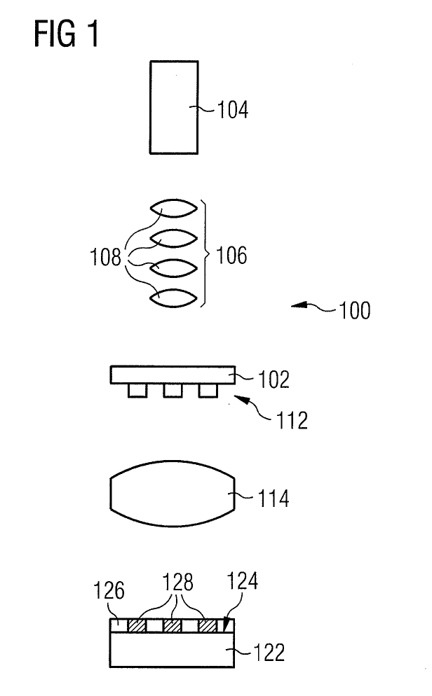

With respect to FIG. 1, a set-up of a lithographic projection apparatus 100 is shown in a side view. It should be appreciated that FIG. 1 merely serves as an illustration, i.e., the individual components shown in FIG. 1 neither describe the full functionality of a lithographic projection apparatus 100 nor are the elements shown in true scale. Furthermore, the described embodiment uses a projective optical system in the UV range employing a certain demagnification. However, other lithographic system including proximity projection, reflective projection or the like employing various wavelengths from the visible to ultraviolet to extreme ultraviolet range can be employed.

The projection apparatus 100 comprises a light source 104, which is, e.g., an Excimer laser with 193 nm wavelength. An illumination optic 106 projects the light coming from the light source 104 through a photo mask 102 into an entrance pupil of the projection system. The illumination optic 106 is comprised of several lenses 108, as shown in FIG. 1, which are arranged between the light source 104 and photo mask 102.

The photo mask 102 comprises a mask pattern 112 composed of light absorptive or light attenuating elements. Light absorptive elements can be provided by, e.g., chrome elements. Light attenuating elements can be provided by, e.g., molybdenum-silicate elements. The mask pattern is derived from a layout pattern which can be provided by a computer aided design system, in which structural elements of the layout pattern are generated and stored.

The light passing the photo mask 102, i.e., not being blocked or attenuated by the above mentioned elements, is projected by projection lens 114 onto the surface 124 of a semiconductor wafer 122. The pattern projected on the semiconductor wafer 122 is usually de-magnified, e.g., scaled down by factor of 4 or 5. For the optical characteristics of the projection apparatus 100, the main contributions are determined by the light source 104, the illumination optic 106, and the projection lens 114 which are further commonly denoted as projection system.

A photo resist film layer 126 is deposited on the semiconductor wafer 122. Onto the resist film layer 126, the mask pattern 112 is projected. After developing the photo resist film layer 126, a three dimensional resist pattern 128 is formed on the surface of the semiconductor wafer 122 by removing those parts of the photo resist film layer 126 which are exposed with an exposure dose above the exposure dose threshold of the resist film layer 126 (or alternatively, those parts of the photo resist film layer that are not exposed can be removed, depending on the composition of the photo resist film and processing substances).

Before the layout pattern is fabricated in a high volume manufacturing process, several set-up procedures can be performed including optimizing the illumination process and implementing so called resolution enhancement techniques (RET) which improve the resolution capabilities of the lithographic projection apparatus.

Currently, there are several concepts known in the art which address the problem of increasing the resolution capabilities. According to a first example, off-axis illumination in the projection system of the projection apparatus together with sub-resolution sized assist features is used. In a second example, the concept of alternating phase shift masks is employed so as to enhance the resolution capabilities of the projection apparatus.

Off-axis illumination is achieved by providing an annular-, quasar- or dipole-shaped aperture stop in a conjugated plane of the illumination optic 106 of lithographic projection apparatus 100 thus enhancing contrast and depth of focus of densely spaced patterns. In turn, off-axis illumination often impairs imaging of isolated structures. In order to allow imaging of isolated structures, sub resolution sized assist features are used which facilitate the resolution of these structures.

In order to achieve dimensional accuracy of the mask pattern during imaging, the sub-resolution sized assist features are determined using a simulation model of the photolithographic projection. In order to perform this calculation, a model for forming an aerial image, a model of the resist exposure, and for the photo mask is provided. The result of the simulation is returned to the layout program so as to alter the geometric structures before production of photo mask 102.

The simulation includes a description of the lithographic apparatus including different kind of optical parameters. These parameters include but are not limited to a polarization state of the light source 104, aberration parameters derived for the optical projection apparatus 100, and illumination mode as achieved by the aperture stop.

During set up of optical lithography processes, a simulation can be performed in which desired layout patterns and simulated images on the wafer are compared. According to this procedure, differences between the desired layout pattern and the resist pattern 128 can be minimized.

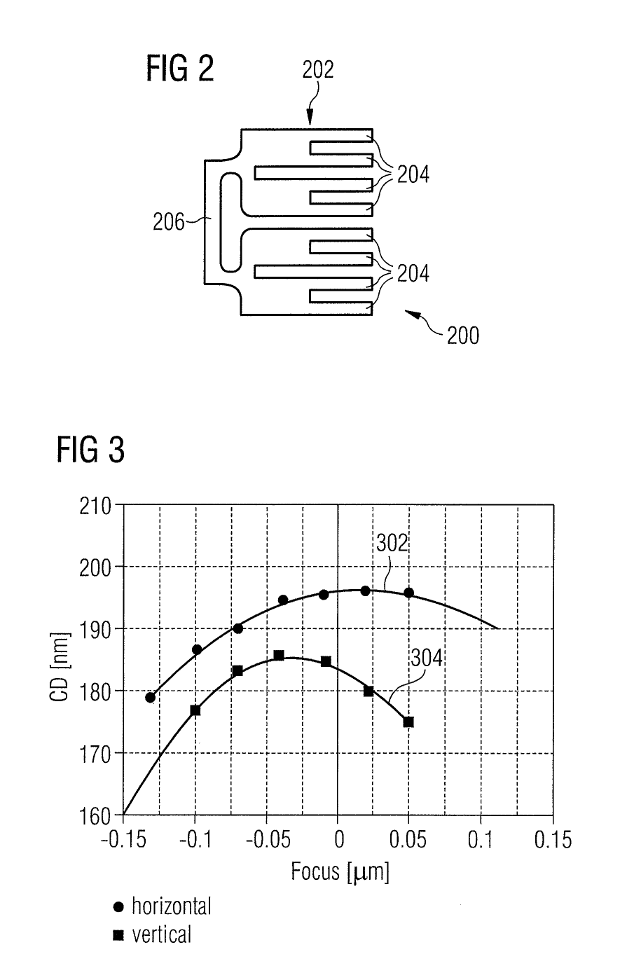

As an example, a fraction of a layout pattern for a specific layer is shown in FIG. 2 in a top view. The layout pattern 200 includes a critical structure in DRAM manufacturing with a line-space array 202 having horizontal parallel lines 204 and a vertical line 206. The exemplary layout pattern can be used as pattern for a layer serving as an interface between a cell array within a memory chip and peripheral circuits. Topological representations of memory cells and layout arrangements for peripheral circuits are known in the art and are therefore not discussed further.

Referring now to FIG. 3, results of a lithographic simulation is described when using a presently available state of the art simulation tool. Simulation tools are provided by many manufactures, including Mentor Graphics Inc., ASML Inc., or other companies.

In particular, the lithographic simulation includes optical parameters for which a polarization in the TE-mode and dipole illumination of light source 104 is chosen. The optical simulation is performed such that, in the simulated image, the simulated line width of the resulting structure is plotted against the beam focus along the projection plane behind the projection optics. The simulation is independently conducted for structures having substantially horizontal and vertical structures, i.e., for structures being arranged substantially perpendicular. The nominal values of the desired layout pattern are 200 nm for both cases.

In FIG. 3, a curve 302 describing the line width versus focus behavior for horizontal lines and a curve 304 describing the line width versus focus behavior for vertical lines are shown. As it is apparent form FIG. 3, the nominal values are different for both cases. Even more important, however, is the fact that both curves 302 and 304 show a behavior with different maxima and slopes, which indicates that best focus conditions are different for different orientations.

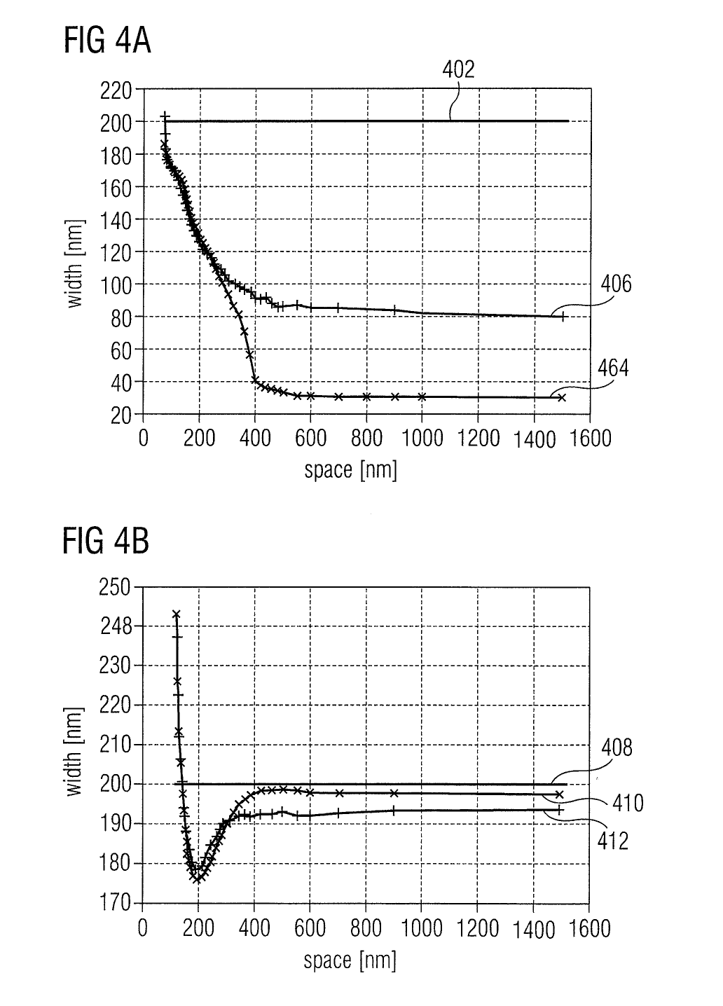

The behavior is further investigated making reference now to FIGS. 4A and 4B. FIGS. 4A and 4B both illustrate a proximity simulation, wherein line elements with a predetermined width having an adjacent neighboring line are simulated for different distances between the two lines. This kind of simulation is often a prerequisite for optical proximity corrections, as explained above. In these diagrams, for each of the above described orientations a predetermined focus value is selected during simulation. The simulation is performed using either a horizontal line (according to FIG. 4A) or a vertical line (according to FIG. 4B) with a target line width of 200 nm which has a varying distance to a further structural element. In both figures, the line width is plotted against the space to the neighboring further structural elements.

In FIG. 4A, a reference line 402 indicating the target value is depicted. Following this, the reference line 402 shows no dependency on the distance to the neighboring structural element and is thus depicted as a flat line at 200 nm line width. The simulated line width 404, however, shows a strong dependency on the pitch, i.e. the distance to the neighboring structural feature.

In a similar way, FIG. 4B depicts a further reference line 408 as a flat line at 200 nm line width. The simulated line width 410 also shows a strong dependency on the distance to the neighboring structure.

Simulation results are further illustrated when comparing the simulated line width 404 for a horizontal line or the simulated line width 410 for a vertical line with corresponding measured line width values. In FIG. 4A, measured values 406 for the line width under similar conditions are depicted. The measured values 406 are derived from a lithographic projection using lithographic projection apparatus 100 onto a test substrate. Similar, FIG. 4B also shows measured values 412 for a vertical line.

As it can be seen from FIG. 4A, the measured values 406 deviate from the simulated line width 404. In FIG. 4B, there is also a deviation between measured and simulated images. The deviation is however less pronounced as compared to FIG. 4A. In summary, when using dipole illumination and a polarized light source 104, the simulated and measured data show a strong orientation-related dependency on beam focus conditions which results in different best focus settings and furthermore in different pattern fidelity for differently oriented patterns on a photo mask.

This behavior can be attributed by considering aberration during lithographic simulation. Aberration is usually described using Zernike coefficients. There, circular wavefront profiles can be fitted with Zernike polynomials. This leads to a set of Zernike coefficients that individually represent different types of aberrations and are linearly independent. Accordingly, individual aberrations contribute to an overall wavefront and can be isolated and quantified separately.

The first Zernike polynomials are equal to the mean value of the wave front amplitude, describe the deviation of the beam in the sagittal and tangential direction, describe a parabolic wavefront shape which results from defocus, attribute to a horizontally or vertically oriented cylindrical shape, describe flaring in the horizontal and vertical direction, and are attributed to a third order spherical aberration.

Aberration coefficients can be determined by a measurement. These measurements are usually performed by using wavefront analyzer system as provided by the ILIAS system from ASML Inc. or the LITEL test reticle. As a result, Zernike coefficients can be derived from these measurements which can be forwarded to an optical model as optical parameters.

When using an asymmetric illumination mode, e.g., dipole illumination, the distributed rays form light source 104 yield to local heating of the lens in lithographic projection apparatus 100. Local heating is a source for thermal stress which in turn affects the optical performance and can lead to an increased aberration. Accordingly, the wavefront measurements can be performed in the steady state of the illumination optics 104, i.e., after local heating stresses have reached equilibrium and are constant over time.

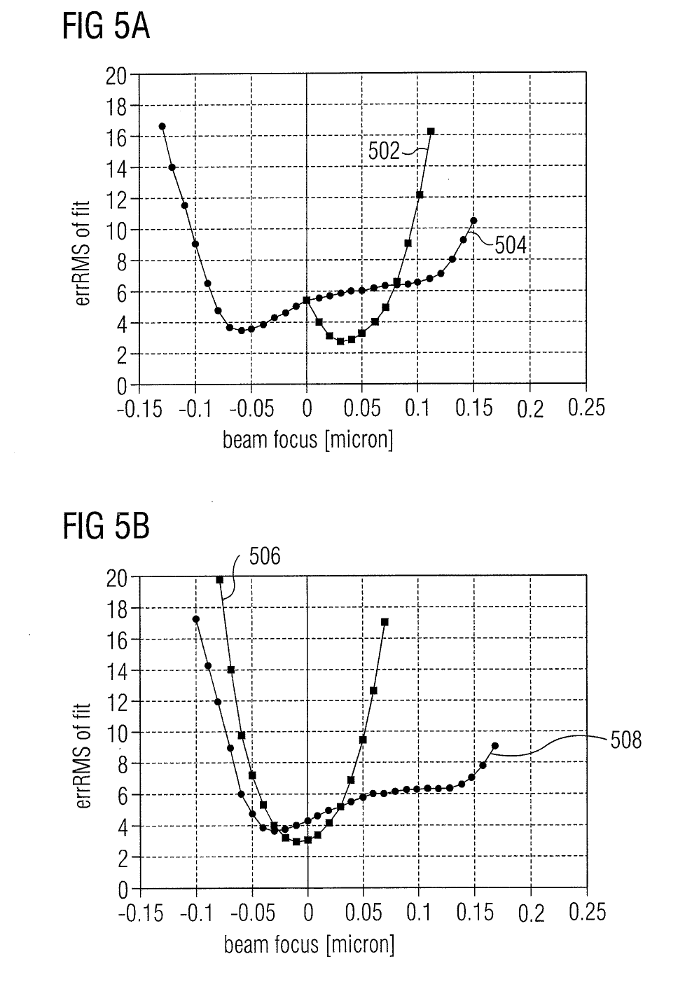

In FIG. 5A, a characterization of fit accuracy obtained from the optical model for different focus settings is illustrated. There, projection of a layout pattern is simulated in both the horizontal and the vertical direction. The pattern used for simulation includes a grid of several lines with different sizes and spacing in order to describe the lithographic projection for several topological conditions. For both directions, an error function is calculated which determines the accuracy of the resulting simulation when compared to the measured value. The fit accuracy can be determined by statistical functions, i.e., calculating an RMS-value or the like.

For the fit accuracy representation shown in FIG. 5A, no aberration coefficients have been taken into consideration. The resulting error function 502 for the vertical direction shows an optimum setting for the beam focus at a value of approximately 0.03 μm. The resulting error function 504 for the horizontal direction shows an optimum setting for the beam focus at a value of approximately −0.07 μm. Following this, there is according to the fit accuracy representation, no adjustment for the focus position available which simultaneously optimizes structures in the horizontal and the vertical direction.

In FIG. 5B, a similar characterization of fit accuracy obtained from the optical model for different focus settings is illustrated. There, aberration coefficients have been taken into consideration. The resulting error function 506 for the vertical direction and the resulting error function 508 for the horizontal direction both show a rather similar optimum setting for the beam focus at a value between approximately −0.03 μm and −0.01 μm. Accordingly, an adjustment for the focus position is available which simultaneously optimizes structures in the horizontal and the vertical direction.

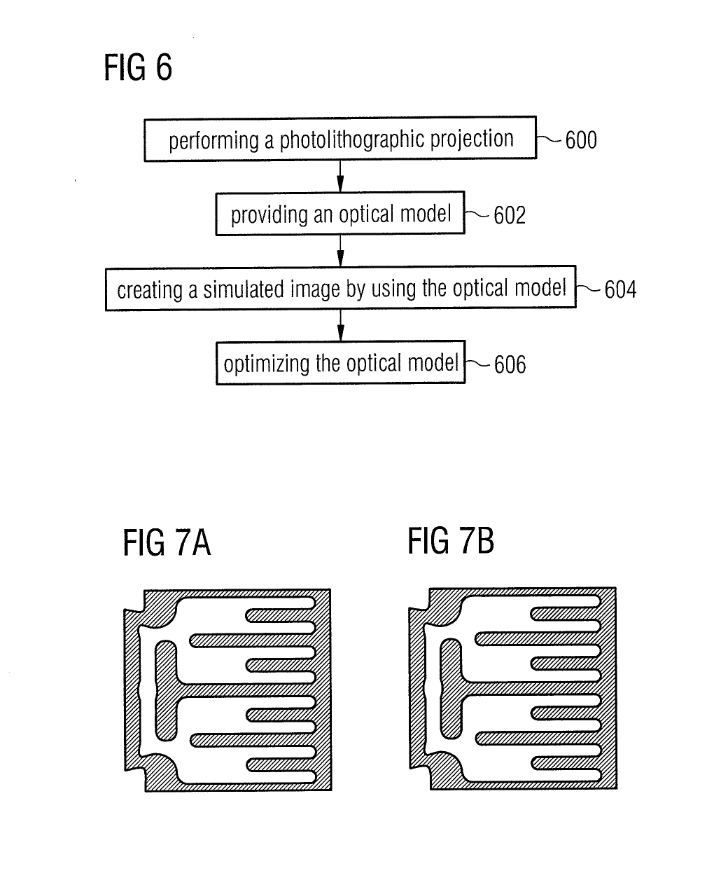

With respect to FIG. 6, a flow chart is depicted which shows individual steps of adjusting an optical parameter of an exposure apparatus

In step 600, a photolithographic projection is performed. The lithographic projection uses the exposure apparatus 100 and illumination conditions including polarization of light source 104 and/or off-axis illumination. On the photo mask 102 the layout pattern is provided as the mask pattern 112. As a result of the lithographic projection, measured pattern data 128 are derived from the developed resist pattern onto the substrate 122.

The measured pattern data are provided with different focus settings of the exposure apparatus 100. During this step, focus dependent parameters of the printed resist pattern 122 can be calculated and stored similar as shown in FIGS. 3 and 5. The measured pattern data are determined in the thermal steady state of the exposure apparatus 100 in order to achieve stable descriptions of aberrations caused by lens heating effects.

In step 602, the optical model is provided. The optical model is suitable to describe the exposure apparatus 100 under the selected illumination conditions. This is achieved within the optical model by including one or more optical parameters, which are suitable to describe polarization state of light source 104 and/or off-axis illumination.

Using now in step 604 the optical model together with layout pattern, a simulated image is created. The simulated image can be calculated with different focus settings of the exposure apparatus. During this step, focus dependent parameters of the simulated image can be calculated. As an example, error functions as described with respect to FIG. 5 or focus dependency as described with respect to FIG. 3 can be calculated and stored for further processing.

In step 606, the optical model is optimized by adjusting the optical parameter so as to reduce an overall difference between the measured pattern data and the simulated image. The differences between the measured pattern data and the simulated image can be determined along a first and a second direction. As already explained with respect to FIG. 2, the first and the second direction can be chosen substantially perpendicular along horizontally and vertically arranged structural elements of the layout pattern. An embodiment for optical model optimization could be, e.g., the introduction and adjustment of aberration parameters, in order to improve the fit accuracy from a situation as shown in FIG. 5A to a situation shown in FIG. 5B. Adjustment criterion would be here the simultaneous achievement of acceptable fit accuracies for different layout orientations.

It should be noted that for the step of optimizing the optical model, measured aberration parameters can be used as starting value for the optical parameter. However, if the resulting images are not sufficiently similar, the one or more optical parameters can be further adapted in an iterative way, in order to resemble the measured pattern data with higher accuracy.

The adaptation of the optical parameter of the optical model can be performed in several ways. It should be noted that either measured parameters can be used from which Zernike coefficients are originating. Furthermore, the optical parameter can be extended so as to not only resemble the true physical aberration but minimize the differences to the measured pattern. This can be accounted for by modifying the optical parameter accordingly even so the parameter appears unphysical from the measurements.

As a measure for studying the accuracy of the optical model, best beam focus can be used. To this extent, the optical parameter is modified to resemble the position of the best beam focus along two directions, i.e., the horizontal and vertical arrangement of the structural elements. Optical parameters can furthermore be modified so as to not only derive best focus positions but minimize the differences in shape between error functions along different directions as shown in FIGS. 5A and 5B.

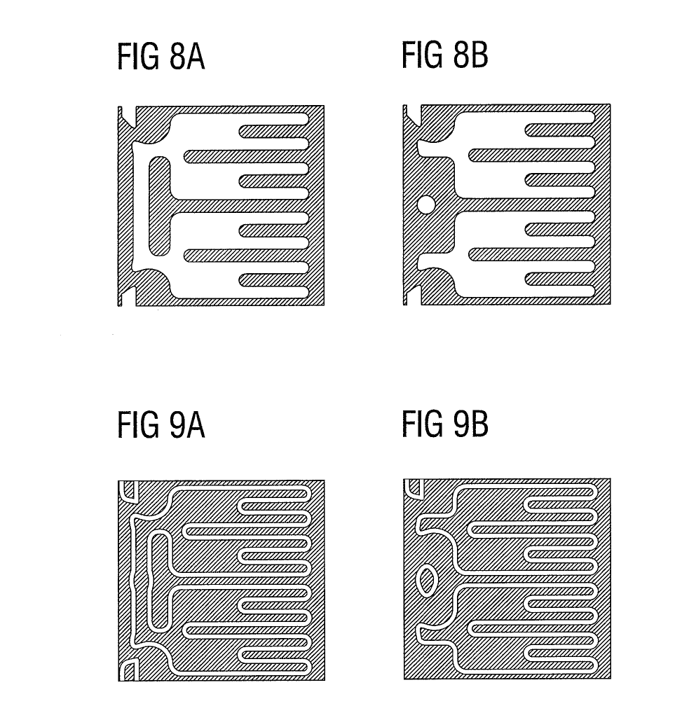

The result of the procedure is further outlined with respect to FIGS. 7A and 7B, 8A and 8B, and 9A and 9B. FIGS. 7A and 7B each illustrate a simulated resist pattern in a top view with respect to a first aberration parameter. There, the optical model does not describe aberration. FIG. 7A shows a simulated resist pattern for the best focus value while FIG. 7B depicts a simulated resist pattern at a defocus of −90 nm. FIGS. 8A and 8B each illustrate a simulated resist pattern in a top view with respect to a second aberration parameter, both for best focus position in FIG. 8A and at a similar defocus in FIG. 8B as compared to FIG. 7B. FIGS. 9A and 9B each illustrate a measured resist pattern for both focus positions.

From the figures, it can be concluded that the real situation is quite closely resembled in both simulations for best focus conditions as differences between FIG. 7A, FIG. 8A and FIG. 9A are rather subtle. In defocus, however, the optical model which does not properly describe aberrations fails to predict the measured resist pattern. There are, however, substantially no differences between FIG. 8B and FIG. 9B which outlines the performance of the optical model using an optical parameter suitable to describe aberration in lithographic projection.

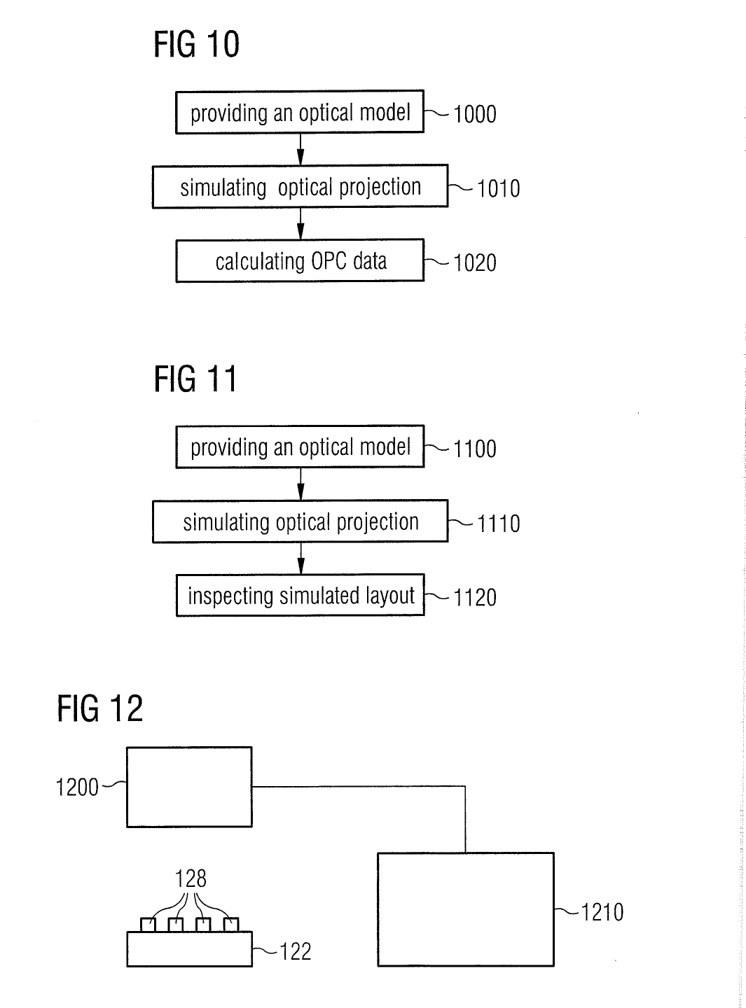

In FIG. 10, a flow diagram is shown in which the concept of adjusting an optical model is further extended to a model for optical proximity correction. There, structural elements are modified, e.g., by modifying their shape or by adding additional elements, in order to more precisely achieve the desired layout pattern on a substrate. These modifications include additional structural elements, hammerheads, serifs and the like. The concept of optical proximity correction (OPC) is an established procedure and is well known in the art. In order to derive at a certain modified layout, the optical projection is simulated using the above described optical model. In general, optical proximity correction includes inserting, removing, relocating or modifying assist features to the layout data. In addition, relocating and modifying features within the layout pattern can be performed. As a result, optical proximity correction adapts modified layout data and layout data to a desired target image.

In a first step 1000, the optical model is provided which includes the optical parameter optimized as described with respect to FIG. 6. In step 1010, the optical projection is simulated using the optical model. In step 1020, the OPC data are calculated. It should be noted that for a layout pattern used in manufacturing different kinds of memory circuits, as, e.g., DRAMs, FeRAM, NROM or the like, a so-called cell array is present which is located at the position of the individual memory cells. The cell array comprises very dense individual elements in order to arrive at high density memory cells. The cell array is surrounded by periphery structures which are used to select certain memory cells during operation of the memory chip. While the cell array comprises a regular pattern, the periphery structures quite often are represented by different patterns having line elements both in vertical and horizontal directions. For lithographic projection, the illumination conditions are usually selected so as to precisely image the cell array without any optical proximity correction applied. For the periphery structures, optical proximity correction is then, however, even more challenging and requires a very precise optical model as described above.

In FIG. 11, a flow diagram is depicted in which the concept of adjusting an optical model is further extended to a full chip simulation which can be used to identify critical elements during lithographic projection.

In a first step 1100, the optical model is provided which includes the optical parameter optimized as described with respect to FIG. 6. In step 1110, the optical projection is simulated using the optical model. In step 1120, the simulated layout is inspected.

With respect to FIG. 12, a system for adjusting an optical parameter of an exposure apparatus is shown. A measurement device 1200 is provided which can be used to determine a set of measured pattern data, which were printed on the wafer 122. As a measurement device, a scanning electron microscope can be used or any other tool, as a scatterometer suitable to resolve the structures printed on the wafer can be employed. The measured pattern consists of data being determined under different focus settings of the exposure apparatus 100.

As already described above, the optical model can be used to describe the exposure apparatus 100. The optical model includes the at least one optical parameter. As a result from the calculation, the simulated image is calculated with different focus settings of the exposure apparatus. A processor 1210, e.g., a computer or any other device suitable for performing calculations, performs the adjusting of the optical model in order to reduce the differences between the measured pattern data and the simulated image.

Having described embodiments of the invention, it is noted that modifications and variations can be made by persons skilled in the art in light of the above teachings. It is therefore to be understood that changes may be made in the particular embodiments of the invention disclosed which are within the scope and spirit of the invention as defined by the appended claims.

What is claimed is:

1. A method of adjusting an optical parameter of an exposure apparatus, comprising:
performing a photolithographic projection using an exposure apparatus and using a layout pattern so as to provide measured pattern data as printed on a substrate with different focus settings of the exposure apparatus;
providing an optical model to describe the exposure apparatus, the optical model including at least one optical parameter;
creating a simulated image by using the optical model and the layout pattern, the simulated image being calculated with different focus settings of the exposure apparatus; and
optimizing the optical model by adjusting the at least one optical parameter so as to reduce an overall difference between the measured pattern data and the simulated image for the different focus settings, the overall difference being determined along a first direction and a second direction in the measured pattern data and in the simulated image.

2. The method according to claim 1, wherein minimizing differences of focus conditions further comprises:
calculating error values between the measured pattern data and the simulate image along the first and second directions for different focus settings; and
adjusting the optical parameter so as to minimize the error values.

3. The method according to claim 1, wherein the optical parameter comprises an aberration parameter.

4. The method according to claim 3, wherein an initial value of the aberration parameter is derived by performing a wavefront measurement of a projection system of the projection apparatus.

5. The method according to claim 3, wherein the aberration parameter is described as a Zernike polynomial having coefficients.

6. The method according to claim 5, wherein the coefficients are modified during optimization of the optical model.

7. The method according to claim 3, wherein the aberration parameter is measured in a steady state of a projection system.

8. The method according to claim 7, wherein the steady state includes the steady state of thermal heating of one or more lens elements of the exposure apparatus.

9. The method according to claim 1, wherein the optical parameter is adjusted so as to minimize a best focus difference, the best focus difference being determined as a minimum of the overall difference.

10. The method according to claim 1, wherein the first and second directions are substantially perpendicular to each other.

11. A method of simulating lithographic projection, comprising:
providing at least one parameter adapted to describe aberration of a projection system including an illumination source suitable to emit polarized light;
providing layout data and generating a reticle from the layout data;
performing a photolithographic projection to create a pattern using the illumination source and the reticle and measuring pattern data from the pattern created for different focus settings;
providing an optical model including the at least one parameter;
creating a simulated image by using the optical model and the layout data for different focus settings;
comparing the measured pattern data and the simulated image; and
optimizing the at least one parameter by reducing an overall difference between the measured pattern data and the simulated image for different focus settings.

12. The method according to claim 1, further comprising:
using the optical model and the optimized parameter to calculate a further set of layout data.

13. The method according to claim 11, wherein optimization of the at least one parameter further comprises a focus difference calculation along a first direction and a second direction in an image plane.

14. The method according to claim 13, wherein optimization of the at least one parameter further comprises determining a best focus in an image plane along the first direction and determining a best focus in an image plane along the second direction using the optical model.

15. The method according to claim 11, wherein the optical parameter comprises an aberration parameter.

16. The method according to claim 15, wherein an initial value of the aberration parameter is derived by performing a wavefront measurement of the projection system.

17. The method according to claim 15, wherein the aberration parameter is described as a Zernike polynomial having coefficients.

18. A method of performing an optical proximity correction, comprising:
performing a photolithographic projection using an exposure apparatus and using a layout pattern so as to provide measured layout data with different focus settings of the exposure apparatus;
providing an optical model to describe the exposure apparatus, the optical model including at least one optical parameter;
creating a simulated image by using the optical model and the layout pattern, the simulated image being calculated with different focus settings of the exposure apparatus;
optimizing the optical model by adjusting the at least one optical parameter so as to reduce an overall difference between the measured pattern data and the simulated image for the different focus settings, the overall difference being determined along a first direction and a second direction in the measured pattern data and in the simulated image; and
using the model to perform optical proximity correction of the layout pattern.

19. The method according to claim 18, wherein the layout pattern includes a cell portion and a periphery portion.

20. The method according to claim 18, wherein the optical proximity correction comprises inserting, removing, relocating, or modifying assist features.

21. The method according to claim 18, wherein the optical proximity correction of the layout pattern comprises relocating and modifying features in the layout pattern.

22. The method according to claim 18, wherein the optical proximity correction adapts modified layout data and layout data to a desired target image.

23. A system for adjusting an optical parameter of an exposure apparatus, comprising:
a measurement device configured to determine a set of measured pattern data as printed on a substrate;
an optical model configured to describe an exposure apparatus, the optical model including at least one optical parameter and being configured to create a simulated image, the simulated image being calculated with different focus settings of the exposure apparatus; and
a processor configured to create a simulated image from the optical model and to optimize the optical model by adjusting the at least one optical parameter so as to reduce an overall difference between the measured pattern data and the simulated image for the different focus settings, the overall difference being determined along a first direction and a second direction in the measured pattern data and in the simulated image.

24. The system according to claim 23, wherein the processor is further configured adapted to perform optical proximity corrections.

25. The system according to claim 23, wherein the processor is further configured to perform a full layout simulation.

26. A fabrication unit for processing semiconductor products including a system for adjusting an optical parameter of an exposure apparatus, comprising:
a measurement device configured to determine a set of measured layout data as printed on a substrate with different focus settings of an exposure apparatus;
an optical model adapted to describe an exposure apparatus, the optical model including at least one optical parameter and being adapted to create a simulated image, the simulated image being calculated with different focus settings of the exposure apparatus; and
a processor adapted to optimize the optical model by adjusting the at least one optical parameter so as to reduce differences between the measured layout data and the simulated image by minimizing differences of focus conditions determined along a first direction and a second direction in the measured layout data and calculated along the first and the second direction in the simulate image.

27. A method of manufacturing an integrated circuit comprising at least one layer lithographically structured using a mask, the mask comprising a layout from a set of layout data, the set of layout data being calculate by using an optical model and an optimized parameter, the method comprising:
providing at least one parameter configured to describe aberration of a projection system including an illumination source suitable to emit polarized light;
providing layout data and generating a reticle from the layout data;
performing a photolithographic projection to create a pattern using the illumination source and the reticle and measuring pattern data from the pattern created for different focus settings;
providing an optical model including the at least one parameter;
creating a simulated image using the optical model and the layout data for different focus settings;
comparing the measured pattern data and the simulated image; and
optimizing the at least one parameter by reducing an overall differences between the measured pattern data and the simulated image for different focus settings.
